(19) United States
(12) Patent Application Publication
(10) Pub. No.: US 2007/0289092 A1
(43) Pub. Date: Dec. 20, 2007

(54) METHOD FOR MANUFACTURING A HINGE MECHANISM FOR VEHICLE SEAT, HINGE MECHANISM MANUFACTURED ACCORDING TO SUCH A METHOD AND VEHICLE SEAT INCLUDING SUCH A HINGE MECHANISM

(75) Inventors: Rene Rohee, La Chapelle (FR); Francois Cilliere, La Chapelle La Forge (FR)

Correspondence Address: MILLER, MATTHIAS & HULL, ONE NORTH FRANKLIN STREET, SUITE 2350, CHICAGO, IL, 60606, US

(73) Assignee: FAURECIA, Sieges d' Automobile, Nanterre (FR)

(21) Appl. No.: 11/744,042

(22) Filed: May 3, 2007

(30) Foreign Application Priority Data
May 5, 2006 (FR) FR 06 04066

(51) Int. Cl. A47C 7/02; B21D 53/40; E05D 7/00

(52) U.S. Cl. 16/221; 29/11; 297/452.1

(57) ABSTRACT

Method for manufacturing a hinge mechanism including:
a movable flange and a stationary flange;
holding means for ensuring holding of the stationary and movable flanges.

The method includes the following steps:
the holding means are applied to the stationary flange, a portion of the holding means being in radial contact with an outside portion of the movable flange,
the holding means are fastened to the stationary flange,
at the same time, a clamping pressure is applied to the holding means, this clamping pressure being directed radially in order to apply a radial pressure of the holding means on the movable flange, so as to take up the play in the hinge.

### FIELD OF THE INVENTION

This invention relates to methods for manufacturing a hinge mechanism for a vehicle seat, to hinge mechanisms manufactured by such methods as well as to vehicle seats including such hinge mechanisms.

More particularly, the invention relates to a method for manufacturing a hinge mechanism for a vehicle seat intended to connect two seat elements, the hinge mechanism including:
a movable flange and a stationary flange extending in substantially parallel planes and intended to be fastened to the two seat elements, respectively,
an adjusting device connecting the stationary and movable flanges, associated with a control element in order to enable rotation of the movable flange in relation to the stationary flange, and
a holding device in order to ensure that the stationary and movable flanges are held in relation to each other, the holding device being made integral with the stationary flange.

### BACKGROUND OF THE INVENTION

Such methods for manufacturing a hinge mechanism for a vehicle seat are known, in particular, by the patent application FR-A-2 872 105, which describes a hinge mechanism of the type detailed above. More particularly, it relates to a round hinge intended to be placed between the frame of the seat rest of a seat and the frame of the backrest of this seat, in order to make the backrest reliably tilt-adjustable. To do so, the mechanism comprises bushing followers which are housed and guided inside recesses created on the inside face of the stationary flange, which is held against the movable flange by a circular cage crimped or welded around two flanges. This cage or ring enables relative rotation between the two flanges.

### OBJECTS AND SUMMARY OF THE INVENTION

In particular, the purpose of this invention is to propose a new method of assembling two stationary and movable flanges so as to take up the play in the hinge mechanism.

To this end, according to the invention, a method for manufacturing a hinge mechanism of the type in question is characterised in that it includes the following steps:

(a) the holding device is applied to the stationary flange, a portion of the holding device being in radial contact with an outside portion belonging to the movable flange,

(b) clamping pressure is applied to the holding device, this clamping pressure being directed radially in order to radially apply the holding device to the movable flange in order to take up the play in the hinge, and

(c) the holding device is fastened to the stationary flange while at the same time maintaining said clamping pressure.

Owing to these arrangements, the clamping pressure exerted on the holding device when it is being fastened to the stationary flange makes it possible to take up the working clearance of the movable flange in relation to the stationary flange. In addition, this radial clamping during fastening of the holding device also makes it possible to offset the centre pin of the adjusting device, which also makes it possible to eliminate or minimise the working clearance inside the hinge mechanism.

In various embodiments of the method for manufacturing a hinge mechanism according to the invention, it may be possible to further use one and/or both of the following arrangements:
the holding device includes at least two arc of circle portions made of a rigid material (e.g., such as steel), the clamping pressure being applied to each of said arc of circle portions during step (b);
the holding device consists of two retainer half-rings;
the holding device includes a round retainer ring which is deformed radially during step (b);
the round ring forms a full circle and is deformed locally during step (b);
the round ring extends over at least 360° and is interrupted by a radial slot, said round ring being deformed by bending during step (b);
the holding device is welded to the stationary flange during step (c).

In addition, another object of the invention is a hinge mechanism including:
a movable flange and a stationary flange extending in substantially parallel planes and intended to be fastened respectively to two seat elements,
an adjusting device connecting the stationary and movable flanges, associated with a control element in order to enable rotation of the movable flange in relation to the stationary flange, and
a holding device for ensuring that the stationary and movable flanges are held in relation to each other, the holding device being made integral with the stationary flanges, characterised in that the holding device is applied so as to be in radial contact with the movable flange.

In particular embodiments of the hinge mechanism according to the invention, it is further possible to use one and/or both of the following arrangements:
the holding device includes at least two arc of circle portions made of a rigid material, which are made integral with the stationary flanges separately from one another and which are each applied so as to be in radial contact with the movable flange;
the holding device includes a round retainer ring which forms a full circle and comprises local deformations applied radially to the movable flange;
the holding device includes a round retainer ring which extends over less than 360° and is interrupted by a radial slot;
the adjusting device is designed so as to either selectively immobilise the movable flange or release the movable flange in rotation in response to the control element;
micro-teeth are made on an inside portion of the stationary flange and on an outside portion of the movable flange, respectively, said micro-teeth being arranged opposite one another.

Another object of the invention is a vehicle seat comprising a seat rest and a backrest mounted so as to be movable in rotation in relation to the seat rest, by means of at least one hinge mechanism as defined above.

### BRIEF DESCRIPTION OF THE DRAWINGS

Other characteristics and advantages of the invention will become apparent from the following description of its embodiments, given for illustrative, non-limiting purposes, in reference to the appended drawings.

In the drawings:

FIG. 1 shows a vehicle seat capable of being equipped with a hinge mechanism according to the invention;

FIG. 2a shows a lateral cut-away view, as a partial cross-section along line IIa-IIa of FIG. 2b, of a hinge mechanism known in the prior art;

FIG. 2b shows a cross-sectional view along line IIb-IIb of the hinge mechanism of FIG. 2a;

FIG. 3 shows an enlarged schematic view of the hinge mechanism shown in FIG. 2b;

FIG. 4 shows a partial cross-sectional view of a hinge mechanism according to a first embodiment of the invention;

FIG. 5 shows two half-rings belonging to the hinge mechanism of FIG. 4;

FIG. 6 is a general view of the hinge mechanism of FIG. 4, including the two half-rings shown in FIG. 5;

FIGS. 7 to 10 are partial cross-sectional schematic views of a hinge mechanism according to the second, third, fourth and fifth embodiments of the invention, respectively;

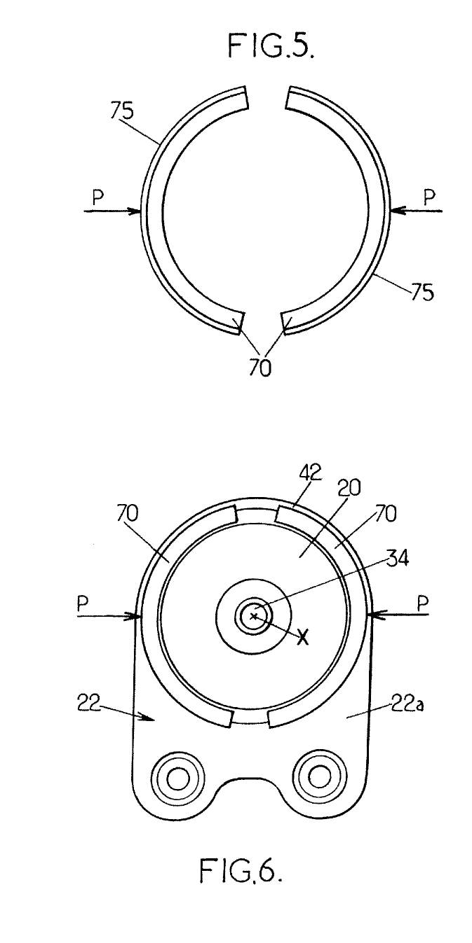

and FIGS. 11 to 14 are views similar to FIG. 6, in the sixth, seventh, eighth and ninth embodiments of the invention.

### MORE DETAILED DESCRIPTION

In the various figures, the same references designate identical or similar elements.

FIG. 1 shows a motor vehicle seat 10, e.g., a front seat, which comprises a seat rest 12 mounted on the floor of the vehicle, e.g., by means of rails. The seat further comprises a backrest 14 which is pivotally mounted on the seat rest 12 about a transverse horizontal axis X, by means of at least one hinge mechanism 16 controlled, for example, by a rotating handle 18.

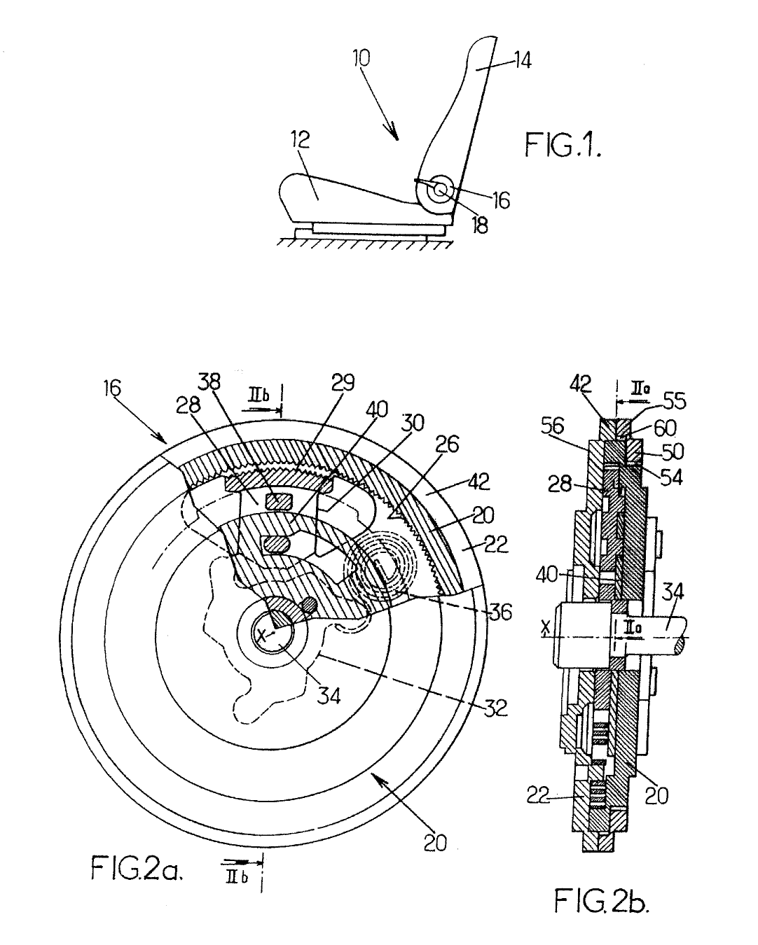

Referring in particular to FIGS. 2a and 2b, in which a hinge already known in the prior art is shown in greater detail, it can be seen that the hinge mechanism 16 comprises first and second support elements which, for example, can be in the form of two movable 20 and stationary flanges 22, made of sheet steel, arranged against each other perpendicular to the transverse axis X of the vehicle, and which can be connected to the frame of the backrest 14 and to the frame of the seat rest 12, respectively.

More particularly, the movable flange 20 made of sheet steel can have an overall circular shape perpendicular to the axis of rotation X. The second stationary flange 22 made of sheet steel can itself comprise at least one circular-shaped part arranged perpendicularly to the axis X, and having an annular edge 42 with an inside face oriented towards the inside of the hinge, and an outside face oriented towards the outside of the hinge. The movable 20 and stationary 22 flanges are mounted pivotally in relation to the each other, about the axis X.

The hinge mechanism 16, which can be seen in more detail in FIG. 2a, further comprises an adjusting mechanism connecting the stationary 22 and movable flanges 20 together.

This adjusting mechanism is a bushing-follower locking device including, for example:
a set of gear teeth 26, internal for example, integral with the movable flange 20, centred on the transverse axis X and, in this case, made in a single piece with the movable flange 20,
one or more bushing followers 28 each bearing a set of gear teeth 26 oriented radially outward, each bushing follower 28 being movably mounted in relation to the stationary flange 22 between:
a locking position wherein the gear teeth 29 of this bushing follower 28 engage with the gear teeth 26 of the movable flange 20,
and an unlocking position wherein the gear teeth 29 of the bushing follower 28 are not engaged with the gear teeth 26 of the movable flange 20; in the example considered here, each bushing follower 28 is mounted so as to slide radially in guides 30 made in a single piece with the stationary flange 22, and
and a cam-operated device, including, on the one hand, a cam 32 integral with a camshaft 34 fastened to the handle 18, and, where appropriate, a control plate 40 integral with the cam 32. The cam 32 is elastically pushed by one or more springs 36, towards a resting position wherein said cam 32 pushes the bushing follower or followers 28 radially outward to their locking position, and the control plate 40 comprises an internal cut-out in which a pin 39 belonging to the corresponding bushing follower 28 is engaged, the outside edge of the cut-out being formed so to act on the pin 38 by moving the corresponding bushing follower 28 to its locking position when the handle 18 is operated.

In FIG. 2b, which is a longitudinal cross-section along the axis IIb-IIb of FIG. 2a, it can be seen that the movable flange 20 and the stationary flange 22 are held adjacent to one another.

The hinge mechanism as known in the prior art, and shown in FIGS. 2a and 2b, further comprises a gusset 50 added on to the stationary flange 22, and which traps the movable flange 20 against the stationary flange 22. The gusset 50, for example, is made of a material such as sheet steel.

This gusset 50, known per se, has the shape of a closed circular rigid ring which is permanently fastened to the stationary flange 22. The gusset 50 is arranged parallel to the stationary flange 22, in the longitudinal direction perpendicular to the transverse axis X. The gusset 50 is superposed on the transverse inside face of the circular edge 42 of the stationary flange 22, without covering the outside face of the latter.

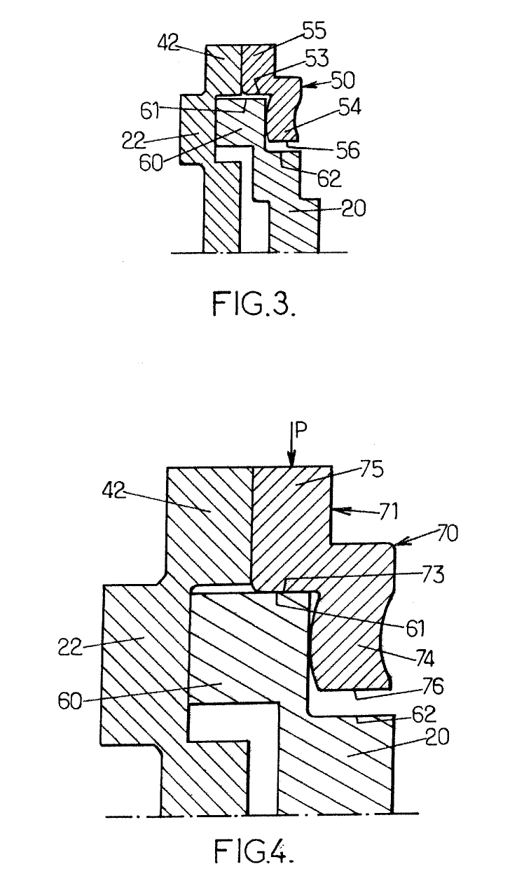

To that end, the gusset 50 has the form of a ring consisting of two portions offset in relation to one another along the transverse axis X. The gusset 50 comprises a first, radially interior portion 54 and a second, radially exterior portion 55, which is intended to be superposed over the inside face of the annular edge 42 of the stationary flange 22. As can be seen in more detail in FIG. 3, the exterior portion 55 of the gusset 50 is, for example, fastened by welding onto the inside transverse face of the annular edge 42 of the movable flange 22 while the interior portion 54 of the gusset 50 comes into contact with the outside transverse face of the annular edge 60 of the movable flange 20 so as to encircle the movable section and thereby create a closed hinge and whose movable 20 and stationary 22 flanges are held against one another when the hinge mechanism is being used. As can still be seen in FIG. 3, the gusset 50 comprises a first radial inside face 53 which is arranged opposite the first radial outside face 61 of the movable flange 20 and a second radial inside face 56 which is arranged opposite the second radial outside face 62 of the movable flange 20.

Thus, as can be seen on this gusset 50, there is considerable clearance between the first and second radial inside faces 53 and 56 of the gusset 50 and the faces 61 and 62 of the movable flange 20, which consequently brings about working clearances in the hinge which are likely to be felt in the backrest 14 of the vehicle seat 10 and thus by the occupant of the seat.

FIGS. 4 to 12 show a holding device according to the invention which replaces the aforementioned gusset by taking up the play in the hinge mechanism.

FIGS. 4 to 6 show a first embodiment in which the holding device includes two circular half-rings 70 which each have a section similar to the aforementioned gusset 50.

Each half-ring 70 comprises two portions offset in relation to one another along the transverse axis X, namely, on the one hand, a first radially interior annular portion 74 and a second radially exterior annular portion 75. The exterior portions 75 of the two half-rings are fastened to the annular edge 42 of the stationary flange 22 separately from one another, e.g., via a laser transparency welding operation that is carried out starting from the transverse outside face 71 of each ring 70. During this transparency welding operation, the outside portion 75 of each half-ring 70 receives a radial clamping pressure P directed towards the axis of rotation X, whereby the radial inside face 73 delimited by the outside portion 75 of each ring 70 comes directly in contact with the radial outside face 61 of the movable section 20. This welding of the two half-rings 70, as well as the placing under pressure of these half-rings 70 on the radial outside face 61 of the movable section 20, thus takes up the play in the hinge mechanism.

As concerns the inside radial face 76 delimited by the inside portion 74 of each half-ring, it remains separated from the corresponding outside radial face 62 of the movable flange 20.

FIG. 5 shows these two half-rings 70 where it can be seen that the clamping pressure P applied can be radially oriented directly towards the axis of rotation X of the hinge. As for FIG. 6, it shows the hinge mechanism once the retainer rings 70 are welded onto the stationary flange 22, this stationary flange 22 comprising, in this alternative embodiment, a top plate 22a radially extending the annular edge 42 and provided with two openings enabling it to be fastened, for example, to the seat rest of the vehicle seat.

In the alternative embodiment shown in FIG. 7, the holding means consist of two half-rings 70 identical or similar to those already described above, or a plurality of ring portions or even a single ring whose peripheral annular edge 75 is fastened via welding directly onto the annular edge 42 of the movable flange 22. In this alternative embodiment, the radial inside face 73 delimited by the outside portion 75 of the ring 70 is not placed in contact with the radial outside face 61 of the movable flange 20, while the radial inside face 76 of the ring 70 comes into contact, via the clamping pressure P, with the outside radial face 62 of said movable flange 20. This contact between the radial inside face 76 of the ring 70 and the outside radial face 62 of the movable flange 20 is accomplished by a clamping pressure P applied to the outside portion 75 of each half-ring 70 while the welding is being performed, e.g., via transparency welding, on the transverse face 71 of the ring 70.

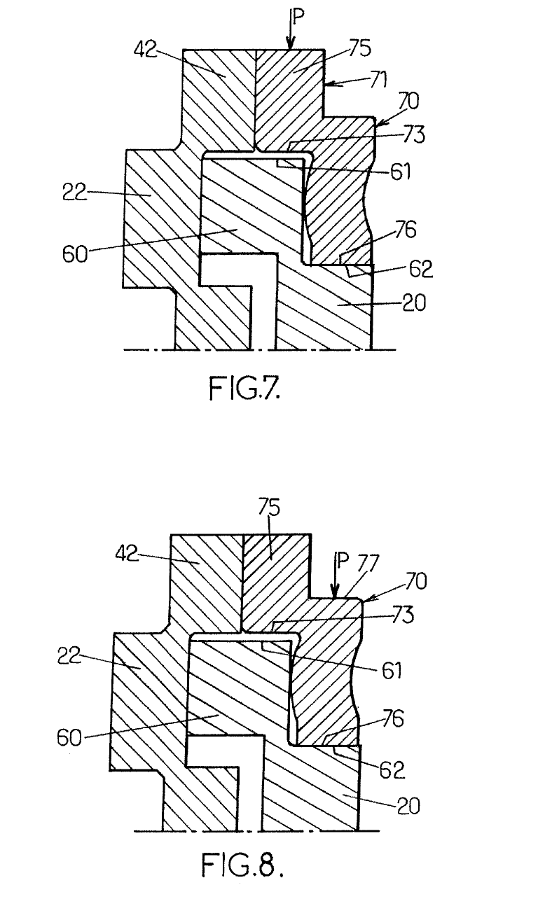

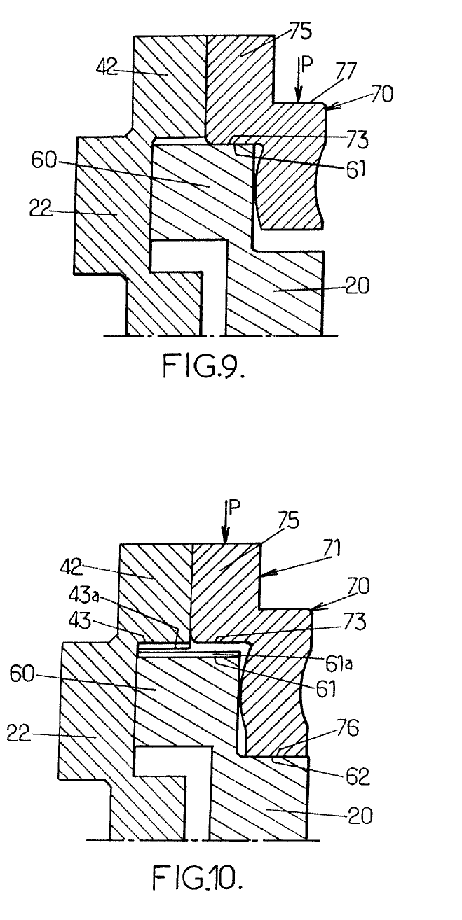

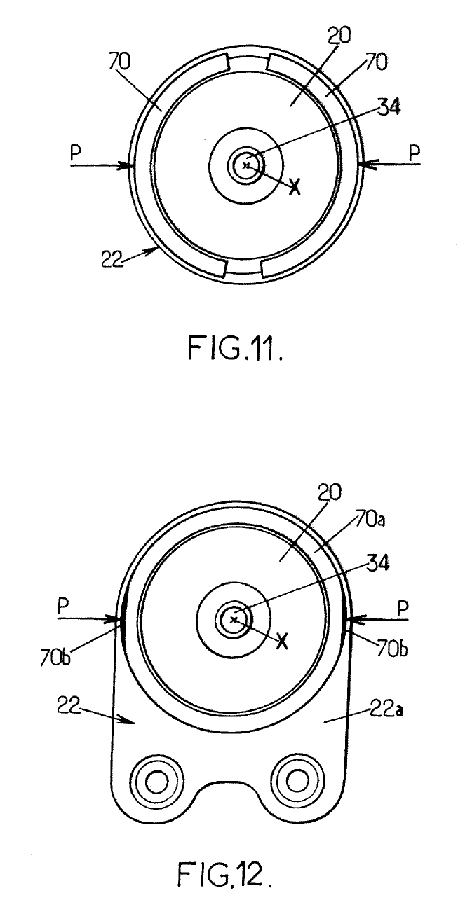

According to another alternative embodiment shown in FIG. 8, and which is substantially similar to that shown in FIG. 7, the inside radial face 76 of each half-ring 70 is placed in contact with the outside radial face 62 of the movable flange 20 via a clamping pressure applied against the radial face 77 of the half-ring 70 while the fastening of the half-rings 70 onto the stationary flange 22 is accomplished via a circular weld seam between the annular edge 75 of the half-ring 70 and the annular edge 42 of the stationary flange 22. In this alternative embodiment, it can also be seen that there is still a clearance between the radial inside face 73 of the half-ring 70 and the outside radial face 61 of the movable flange 20.

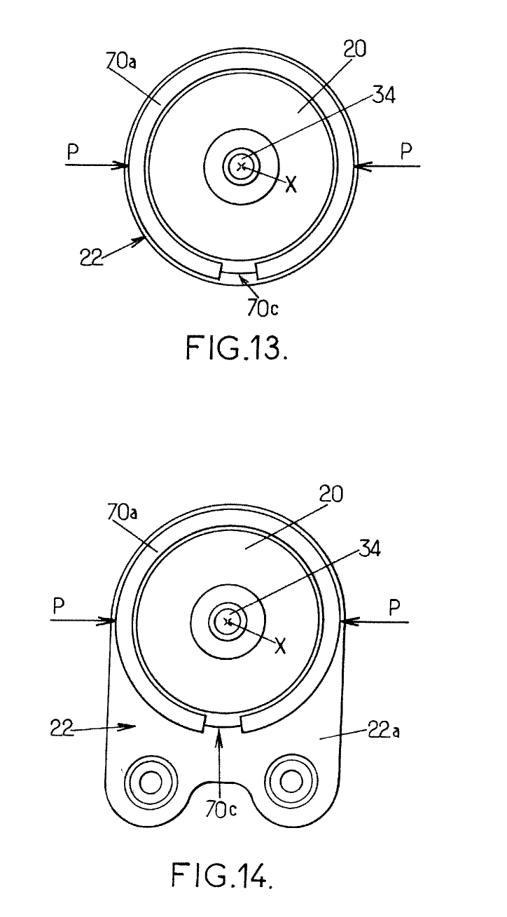

FIG. 9 shows another alternative embodiment in which the radial inside face 73 of each half-ring 70 is stop contact with the outside radial face 61 of the movable flange 20. This stop contact is made via a clamping pressure P applied directly to the outside radial face 77 of the ring 70 when the annular edge 75 of the ring 70 and the annular edge 42 of the stationary flange 22 are welded to one another via a circular weld seam.

FIG. 10 shows another alternative embodiment in which the inside radial face 76 of each half-ring is placed in contact with the radial face 62 of the movable flange 20, all of this being accomplished via a clamping pressure P applied directly to the annular edge 75 of the ring 70, this annular edge 75 being further fastened via welding to the annular edge 42 of the stationary flange 22 via a transparency weld seam applied to the transverse face 71 of the ring 70. As can be seen in this alternative shown in FIG. 10, the radial inside face 73 of the ring 70 is not in contact with the inside radial face 61 of the movable flange 20. This radial outside face of the movable flange 20 is provided with micro-teeth 61a which are arranged opposite micro-teeth 43a made directly on the radial inside face 43 of the annular edge 42 of the stationary flange 22. Thus, in the event of heavy stress exerted on the hinge mechanism, these micro-teeth 43a and 61a can mesh together so as to increase the strength of the hinge.

The sixth embodiment of the invention, shown in FIG. 11, is similar to the various embodiments described above, and is distinguished from them solely by the fact that the stationary flange 22 is circular rather than having the aforementioned top plate 22a.

The various alternatives mentioned above can be applied to this embodiment.

Furthermore, the seventh embodiment, shown in FIG. 12, is distinguished from the embodiments of FIGS. 4 to 11 solely by the fact that the two half-rings 70 are replaced by a single circular ring 70a which is deformed locally, radially inward in diametrically opposing deformation areas 70b in relation to the axis X, when radial pressure P is applied, so as to locally establish radial contact between said circular ring 70a and an outside radial surface 61 or 62 of the movable flange 20, during fastening of the ring 70a to the stationary flange 22.

The various alternatives mentioned above also apply to the embodiment of FIG. 12.

Furthermore, in the embodiment of FIG. 12, it would be possible to locally apply the clamping pressure P at more than two points, e.g., at three points spread apart from each other by 120°, in which case the deformed areas 70b would likewise be spread apart from each other by 120°. It is further noted that the half-rings 70 or the circular ring 70a might be replaced by a plurality of arc of circle portions, numbering more than two, distributed around the flange 20, fastened to the stationary flange 22 separately from one another, and to each of which an inwardly-directed radial clamping pressure P would be applied during fastening of said arc of circle portions to the stationary flange 22.

Finally, in the embodiments of FIGS. 13 and 14, the holding device comprises a single circular ring 70a but, contrary to the embodiment of FIG. 12, this circular ring 70a extends over less than 360° and is interrupted by a radial slot 70c. A split circular ring such as this, for example, can be made from a metal section that is made into a circular shape via rolling. In these two embodiments of the invention, the clamping pressure P is applied at two points that are diametrically opposite and situated substantially at 90° from the slot 70c in relation to the axis X. This pressure P causes bending of the circular ring 70a, which has a tendency to close the slot 70c and thereby establish contact between said circular ring 70a and an outside radial surface 61 or 62 of the movable flange 20, during fastening of the ring 70a to the stationary flange 22. The various alternatives mentioned above can be applied to the two embodiments of FIGS. 13 and 14, which are distinguished from one another solely by the fact that the stationary flange 22 has a circular shape in FIG. 13 whereas it comprises the aforementioned fastening top plate 22a in FIG. 14.

Of course, the adjusting mechanism might consist of a gearing system rather than a locking mechanism such as the one described above.

1. Method for manufacturing a hinge mechanism for a vehicle seat intended to connect two seat elements, the hinge mechanism including:
a movable flange and a stationary flange extending in substantially parallel planes and intended to be fastened to the two seat elements, respectively,
an adjusting device connecting the stationary and movable flanges, associated with a control element in order to enable rotation of the movable flange in relation to the stationary flange, and
a holding device in order to ensure that the stationary and movable flanges are held in relation to each other, the holding device being made integral with the stationary flange, said method including the following steps:
(a) the holding device is applied to the stationary flange, a portion of the holding device being in radial contact with an outside portion belonging to the movable flange,
(b) clamping pressure is applied to the holding device, this clamping pressure being directed radially in order to radially apply the holding device to the movable flange, and
(c) the holding device is fastened to the stationary flange while at the same time maintaining said clamping pressure.

2. Method of claim 1, in which the holding device includes at least two arc of circle portions made of a rigid material, the clamping pressure being applied to each of said arc of circle portions during step (b).

3. Method of claim 2, in which the holding device includes two retainer half-rings.

4. Method of claim 1, in which the holding device includes a round retainer ring which is deformed radially during step (b).

5. Method of claim 4, in which the round ring forms a full circle and is deformed locally during step (b).

6. Method of claim 4, in which the round ring extends over less than 360° and is interrupted by a radial slot, said round ring being deformed by bending during step (b).

7. Method as claimed in claim 1, in which the holding device is welded to the stationary flange during step (c).

8. Hinge mechanism including:
a movable flange and a stationary flange extending in substantially parallel planes and intended to be fastened respectively to two seat elements,
an adjusting device connecting the stationary and movable flanges, associated with a control element in order to enable rotation of the movable flange in relation to the stationary flange, and
a holding device for ensuring that the stationary and movable flanges are held in relation to each other, the holding device being made integral with the stationary flanges, wherein the holding device is applied so as to be in radial contact with the movable flange.

9. Hinge mechanism of claim 9, in which the holding device includes at least two arc of circle portions made of a rigid material, which are made integral with the stationary flanges separately from one another and which are each applied so as to be in radial contact with the movable flange.

10. Hinge mechanism of claim 8, in which the holding device includes a round retainer ring which forms a full circle and comprises local deformations applied radially to the movable flange.

11. Hinge mechanism of claim 8, in which the holding device includes a round retainer ring which extends over less than 360° and is interrupted by a radial slot.

12. Hinge mechanism as claimed in claim 8, in which the adjusting device is designed to either selectively immobilise the movable flange or release the movable flange in rotation in response to the control element.

13. Hinge mechanism as claimed in claim 8, in which micro-teeth are made on an inside portion of the stationary flange and on an outside portion of the movable flange, respectively, said micro-teeth being arranged opposite one another.

14. Vehicle seat comprising a seat rest and a backrest mounted so as to be movable in rotation in relation to the seat rest, by means of at least one hinge mechanism as claimed in claim 8.
